(19) United States
(12) Patent Application Publication
(10) Pub. No.: US 2009/0286640 A1
(43) Pub. Date: Nov. 19, 2009

(54) SPROCKET FOR CHAIN

(75) Inventors: Shunji Sakura, Osaka (JP); Masatoshi Sonoda, Osaka (JP); Akira Hirai, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/409,764

(22) Filed: Mar. 24, 2009

(30) Foreign Application Priority Data
May 14, 2008 (JP) 2008-126571

(51) Int. Cl. F16H 55/30

(52) U.S. Cl. 474/153

(57) ABSTRACT

A sprocket of a chain transmission has at least two different pitch angles arranged irregularly in the direction of the circumference of the sprocket's pitch circle. The diameter of the tooth gap bottom circle of the sprocket is larger than the diameter of tooth gap bottom circle of a standard sprocket having the same number of teeth. The teeth are integrally molded as a part of the sprocket by sintering.

### CROSS-REFERENCE TO RELATED APPLICATION

This application claims priority on the basis of Japanese patent application 2008-126571, filed May 14, 2008. The disclosure of Japanese application 2008-126571 is hereby incorporated by reference.

### FIELD OF THE INVENTION

The invention relates to a sprocket for use with a transmission chain. The periphery of the sprocket has a plurality of teeth separated from one another by tooth grooves, each groove having a tooth gap bottom continuous with facing surfaces of two adjacent teeth. In a chain transmission, rollers of a roller chain, or bushings of a bushing chain, engage with the tooth gaps. It is desirable to reduce noises generated when the roller of a roller chain or the bushing of a bushing chain engages with a sprocket tooth, and to achieve smooth disengagement of the rollers or bushings from the sprocket.

### BACKGROUND OF THE INVENTION

Chain transmissions in which a chain is in meshing engagement with a driving sprocket and one or more driven sprockets are used widely. Regardless of the environment in which they are used, it is generally desirable to reduce the noise level generated in the operation of such chain transmissions.

When the chain transmission is used as a timing transmission in an internal combustion engine, to transmit power from an engine crankshaft to one or more camshafts for operating intake and exhaust valves, it needs to meet the demand for high power output and high combustion efficiency, and meet environmental concerns as well. Thus, whereas the load on the timing transmission has increased, there is a conflicting demand for reduction of the noise generated by the transmission to a negligible level.

Countermeasures for reducing noise in an automobile engine have included the use of sound-absorbing materials such as rubber. However, where the load on the timing transmission is at a high level, and chain tension is high, it has become difficult to suppress noise sufficiently.

These chain transmissions are defined in Japanese Industrial Standards (JIS), and specifically in JIS B1801-1997 (Transmitting roller chain and Bushing chain), and the sprocket tooth forms (S tooth form and U tooth form) are also defined in a reference (“Shapes and Sizes of Sprocket”) attached to JIS B1801-1997. Further, tooth forms for chains and sprockets according to the International Standards Organization (ISO tooth forms) are defined in ISO 606: 1994 (E). Conventional chain transmissions utilizing roller chains or bushing chains together with sprockets are generally made in accordance with these standards.

FIGS. 8 and 9 depict a conventional chain transmission, comprising a standard roller chain 80, and a standard sprocket 90 having an ISO tooth form. FIG. 9 is an enlarged view of a portion Ix in FIG. 8.

The ISO tooth forms shown in FIGS. 8 and 9 are defined by the following expressions from ISO 606: 1994 (E).

| | |
|---|---|
| d = p/sin(180°/z) | (Pitch circle diameter) |
| df = d − d1 | (Diameter of tooth gap bottom |
| | circle, or “root diameter”) |
| dc = df | Caliper diameter for a sprocket |
| | having an even number of teeth |
| dc = d × cos(90°/z) − d1 | Caliper diameter for a sprocket |
| | having an odd number of teeth |
| re(max) = 0.12 × d1(z + 2) | Maximum of radius of tooth head |
| | arc |
| ri(min) = 0.505 × d1 | Minimum of radius of tooth gap |
| | bottom arc |
| re(min) = 0.008 × d1(z² + 180) | Minimum of radius of tooth head |
| | arc |
| ri(max) = 0.505 × d1 + 0.069(d1)^{1/3} | Maximum of radius of tooth |
| | gap bottom arc |

In the above formulae,
p is the roller chain pitch,
d is a pitch circle diameter,
d1 is the outer diameter of a chain roller,
df is the diameter of the tooth gap bottom circle, i.e., the root diameter,
dc is a caliper diameter,
re(max) is the maximum of the radius of the tooth head arc,
ri(min) is the minimum of the radius of tooth gap bottom arc,
re(min) is the minimum of the radius of the tooth head arc,
ri(max) is the maximum of the radius of the tooth gap bottom arc, and
z is the number of sprocket teeth.

In FIGS. 8 and 9, pa is the chordal pitch of the sprocket, which is equal to the chain pitch p. As apparent from the above expressions, in the standard sprocket 90, shown in FIG. 9, the tooth gap bottom 93 of the ISO tooth form is in the form of an arc having a radius ri slightly larger than the radius (d1/2) of roller 82. The tooth surface 92 is in the formed of an arc having a radius re.

The tooth surfaces 92 on both sides of a tooth gap are continuous with the tooth gap bottom 93. The diameter df of the tooth gap bottom circle, is equal to the difference between the pitch circle diameter d and the roller diameter d1. The diameter df of the tooth gap bottom circle is substantially the same as the difference between the pitch circle diameter d and two times the radius ri of the tooth gap bottom arc.

The standard chain 90 includes inner links and outer links arranged in alternating, overlapping relationship along the length of the chain. In each inner link, both ends of each of two bushings are respectively press-fit into bushing holes in a pair of inner plates. Rollers, each having an outer diameter d1, are rotatable on the bushings. In each outer link, both ends of two connecting pins are respectively press-fitted into pin holes of a pair of outer plates. The chain is assembled in such a way that each of the two connecting pins of an outer link extends through a bushing of a different adjacent inner link, so that the links are connected together. The bushings are rotatable on the connecting pins to allow articulation of the chain. The standard roller chain 80 has a uniform chain pitch p, i.e., a uniform distance between the centers of its respective rollers.

In the standard sprocket 90, as shown in FIGS. 8 and 9, the tooth gap bottom 93 and the tooth surfaces 92, which are continuous with the tooth gap bottom 93, are symmetrical with respect to a center line X extending radially from the rotational center O of the sprocket through center of the tooth gap bottom 93. The tooth form pitch angle θ is the angle formed by adjacent center lines X, and, is determined by the number of teeth on the sprocket. That is, the tooth pitch angle θ=360°/z. The tooth form pitch pa is the distance between intersection points a, where the radial center lines X intersect the pitch circle pc. Therefore, the tooth form pitch pa is the length of a chord corresponding to the tooth form pitch angle θ. Since, in the standard sprocket 90, the tooth form pitch angles θ are all the same, the chordal tooth form pitch pa is uniform along the circumference of the pitch circle pc. Furthermore, the chordal tooth form pitch pa is made equal to the chain pitch p.

In another approach to reduction of engagement noise, described in Japanese Examined Patent Application No. Hei 7-18478, the outer diameter the rollers of a roller chain is made larger than the standard size so that, as each roller abuts the opposed surfaces of a pair of adjacent sprocket teeth, a clearance exists between the roller and the tooth gap bottom. The tooth gap bottom is in the form of an arc having a diameter slightly smaller than the outer diameter of the roller. As the roller slides on the tooth surfaces and seats on the tooth gap bottom elastic deformation of the roller and/or the tooth surfaces takes place.

In a conventional transmission device comprising a standard roller chain and a standard sprocket, when the standard sprocket rotates in the clockwise direction as shown in FIG. 8, a following roller 92 moves, relative to a seated preceding roller, circumferentially about the center c of the preceding roller, in an arc having a radius equal to the chain pitch p. The following roller then comes into a substantially right angle collision with a tooth gap bottom. Thus, upon engagement of the following roller 92 with the tooth gap bottom the kinetic energy of the roller is transmitted to the tooth gap bottom without buffering, generating a large amount of vibration and noise.

Since the chordal tooth form pitch pa of the standard sprocket 90 is the same as a pitch p of the standard roller chain 80, each roller 82 abuts the tooth gap bottom of the standard sprocket 90 at the same abutment position. Therefore, the timing of engagement of the rollers 82 with the tooth gap bottoms of the sprocket is uniform, and the frequency of the vibration and noise generated corresponds to the number of sprocket teeth.

In the low noise chain transmission disclosed in Japanese Examined Patent Application No. Hei 7-18478, the angle, formed by a line tangent to the position at which the roller abuts a sprocket tooth surface when the roller seats on the tooth gap bottom and a line connecting the center of the roller and the center of said sprocket, is a small angle. Elastic deformation of the roller and/or the tooth surfaces takes place, and the impact is alleviated so that engagement noise is reduced. However since the roller becomes sandwiched between opposed tooth surfaces, smooth disengagement of the roller from the sprocket is prevented, and vibration of the chain takes place on the side at which the chain disengages from the sprocket, generating noise.

Accordingly, an object of the invention is to solve the above-described problems and to provide a sprocket in which the vibration and noise are reduced and in which disengagement of a chain from the sprocket is smooth and frictional noises are reduced.

### SUMMARY OF THE INVENTION

The sprocket according to the invention is a sprocket for a chain drive, and has teeth separated by grooves for receiving rollers or bushings of a transmission chain. In each groove, facing tooth surfaces are smoothly continuous with a tooth gap bottom. The sprocket has at least two different pitch angles, arranged irregularly in the direction of the circumference of the sprocket's pitch circle. The diameter of tooth gap bottom circle of the sprocket is larger than the diameter of the tooth gap bottom circle of a standard sprocket having the same number of teeth, and the teeth are integrally molded as a part of the sprocket by sintering.

Because the sprocket has at least two different pitch angles, the timing of impact or abutment of the roller or bushing of the chain with the sprocket shifts. Moreover, the kinetic energy of impact is reduced. As a result, engagement noise is reduced, and vibration and noise, at frequencies corresponding to the number of teeth on the sprocket, are also reduced. Further, since the difference between the overall noise of the chain transmission and the periodic sounds that it generates is large, gating noises can be reduced and, at the same time, the following peculiar effects can be obtained.

Since teeth having a plurality of different pitch angles are arranged irregularly along the circumferential direction of the sprocket's pitch circle, and the diameter of the tooth gap bottom circle is larger than the diameter of the tooth gap bottom circle of a standard sprocket, the size of the sprocket teeth is reduced, and vibration and noise can be reliably reduced without loss of durability. Moreover, since the teeth are integrally molded with the sprocket by sintering, no machining requiring complicated control or rolling is needed, and manufacture of the sprocket is relatively easy even though the sprocket has a plurality of different pitch angles. Furthermore, since the sintered sprocket material holds more lubricant in its surface, frictional noise produced by sliding contact of the rollers or bushings of a chain with the sprocket teeth, which can be higher because of the tooth pitch variation, can be also reduced.

In one preferred embodiment of the invention, the pitch angles are θ−Δθ and θ+2Δθ, arranged irregularly in the direction of the circumference of the sprocket's pitch circle, where θ is the pitch angle of a standard sprocket. Preferably, the number of pitch angles in the sprocket equal to θ−Δθ is two times the number of pitch angles in the sprocket equal to θ+2Δθ.

In another preferred embodiment, the tooth form pitch angles are θ, θ−Δθ, and θ+Δθ, arranged irregularly in the direction of the circumference of the sprocket's pitch circle. Preferably, the number of pitch angles in the sprocket equal to θ−Δθ is equal to the number of pitch angles in the sprocket equal to θ+Δθ.]

Where the sprocket has only two or three pitch angles, manufacture of the sprocket is simplified.

### BRIEF DESCRIPTION OF THE DRAWINGS

FIG. 1 is an elevational view of a portion of a sprocket according to first and second embodiments of the invention;

FIG. 2 is an elevational view of a portion of a sprocket according to third and fourth embodiments of the invention;

FIG. 3 is an elevational view of a portion of a sprocket according to fifth and sixth embodiments of the invention;

FIG. 4 is an elevational view of a portion of a sprocket according to seventh and eighth embodiments of the invention;

FIG. 5 is an elevational view of a portion of a standard chain and a sprocket according to the invention, showing the engagement of the chain with the sprocket;

FIG. 6 is an elevational view of a portion of a standard chain and a sprocket according to first, third, fifth and seventh embodiments of the invention, showing the engagement of the chain with the sprocket;

FIG. 7 is an elevational view of a portion of a standard chain and a sprocket according to second, fourth, sixth and eighth embodiments of the invention, showing the engagement of the chain with the sprocket;

FIG. 8 is an elevational view of a portion of a standard chain and a standard sprocket, showing the engagement of the chain with the sprocket;

FIG. 9 is an enlarged view of a portion of the sprocket labeled IX in FIG. 8; and

FIG. 10 is a table showing parameters of the sprockets according to the eight embodiments of the invention, and comparing these parameters with corresponding parameters of a standard sprocket having an ISO tooth form.

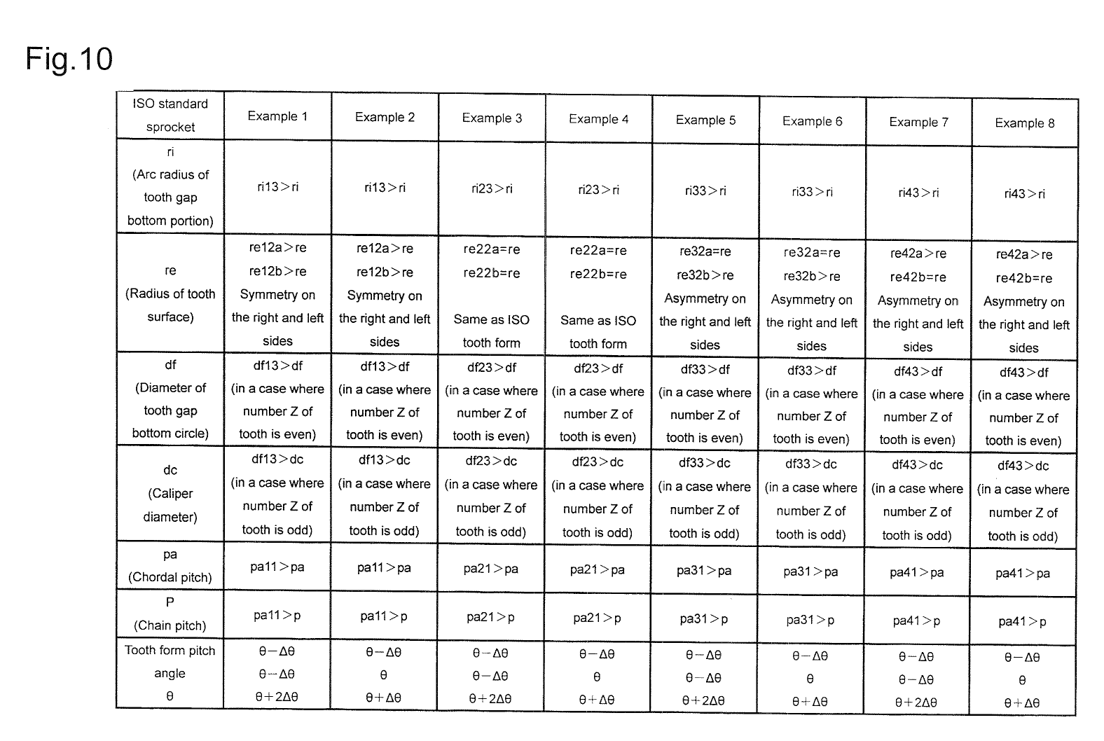

### DETAILED DESCRIPTION OF THE PREFERRED EMBODIMENTS

In general, the sprocket according to the invention has at least two different pitch angles arranged irregularly in the direction of the circumference of the sprocket's pitch circle. The diameter of the tooth gap bottom circle of the sprocket is larger than the diameter of tooth gap bottom circle of a standard sprocket having the same number of teeth. The teeth are integrally molded as a part of the sprocket by sintering.

Vibration and noise, generated when a chain engages with the sprocket, can be reduced by optimization of the sprocket tooth forms and the pitch angles of a sprocket, and disengagement of a chain from the sprocket can be made smooth. Manufacture of the sprocket is easy, and frictional noises are reduced. The sprocket can have any suitable number of teeth, and any number of different pitch angles. In the case of three or more pitch angles, the sprocket may include pitch angles corresponding to those of a standard sprocket having the same number of teeth. The advantages of the invention can be realized in any of a wide variety of embodiments, examples of which will be described.

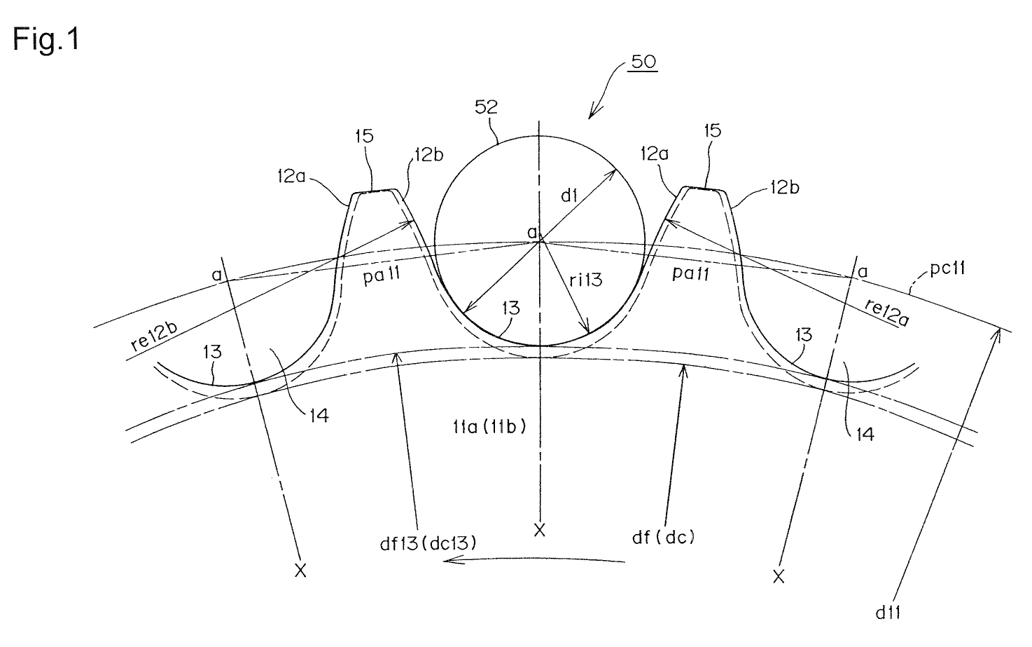

A sprocket 11a for a standard roller chain, having a tooth form as shown in FIG. 1, is adapted for use with a standard roller chain 50.

In the sprocket 11a, adjacent teeth 15 have facing tooth surfaces 12a and 12b, and are separated by a tooth groove 14 having a tooth gap bottom 13, with which the tooth surfaces 12a and 12b are continuous. A standard ISO tooth form is shown by a broken line in FIG. 1 for comparison.

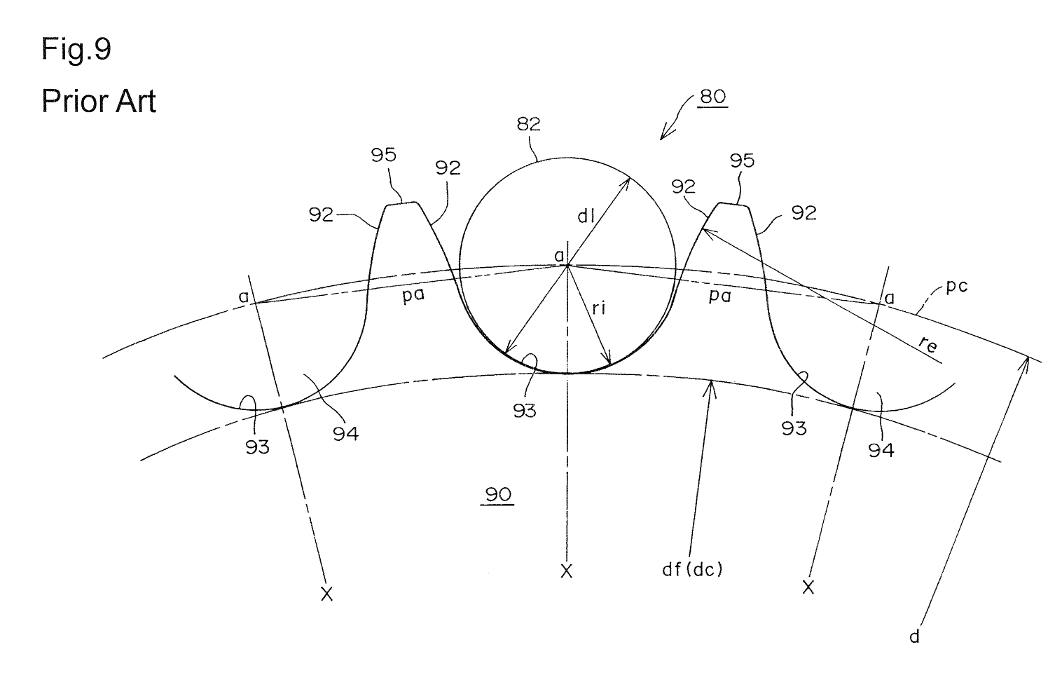

The tooth surface 12a, on the front side of a tooth in the direction of rotation of the sprocket 11a, and the tooth surface 12b on the back surface of the preceding tooth, are symmetrical with respect to a center line X, which extends from the rotational center of the sprocket 11a through the center of the tooth gap bottom 13 between the two teeth. Each of the tooth surfaces 12a and 12b is in the form of a convex arc. The arcs forming the tooth surfaces 12a and 12b have radii re12a and re12b, respectively, both of which are larger than the radius re (FIG. 9) of the arc-shaped tooth surfaces in the Standard ISO tooth form. That is, re12a>re and re12b>re.

The tooth gap bottom 13 is in the form of an arc having its center on the tooth gap bottom center line X, and having a radius ri13, which is larger than the radius ri (FIG. 9) of the arc-shaped tooth gap bottom in the standard ISO tooth form. That is, ri13>ri. The center of the arc-shaped tooth gap bottom 13 is located on the center line X, radially outward relative to the location of the center of the arc-shaped tooth gap bottom in a sprocket having the standard ISO tooth form and the same number of teeth.

Since the center of the arc-shaped tooth gap bottom 13 is positioned outward relative to the center of the arc-shaped tooth gap bottom in a corresponding sprocket having the standard ISO tooth form, the diameter of tooth gap bottom circle of the sprocket is larger than the diameter of the tooth gap bottom circle of the standard sprocket. In particular, when the number z of teeth on the sprocket 11a is even, the diameter df13 of the tooth gap bottom circle is larger than a diameter df of the tooth gap bottom circle in the sprocket having the standard ISO tooth form. That is, df13>df. Alternatively, when the number z of teeth on the sprocket 11a is odd, the caliper diameter dc13 is larger than the caliper diameter dc in the sprocket having the standard ISO tooth form. That is, dc13>dc.

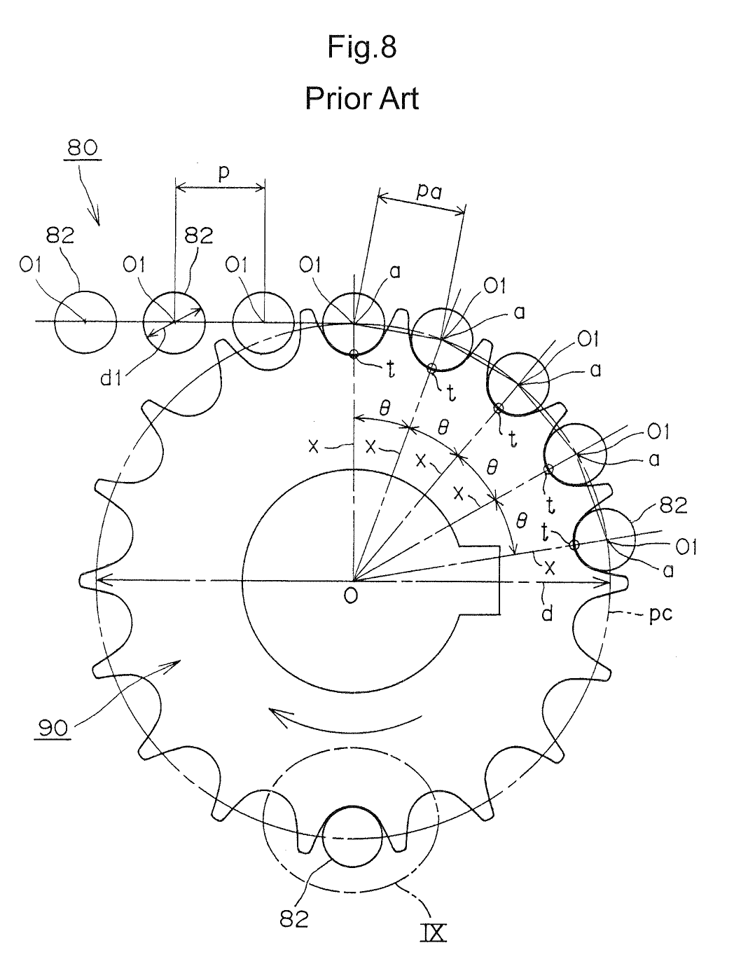

Furthermore, since the diameter df 13 of the tooth gap bottom circle, or the caliper diameter dc13, is larger than the diameter df of the tooth gap bottom circle or the caliper diameter dc in the standard ISO tooth form, the chordal pitch pa11 of the sprocket 11a (that is, the distance between successive intersection points a of the pitch circle pc11 and center lines X of the tooth gap bottoms) is larger than the chordal pitch pa (that is, the distance between successive intersection points a of a pitch circle pc and the center lines X of tooth gap bottoms in a standard sprocket having the standard ISO tooth form as shown in FIGS. 8 and 9. That is, pa11>pa.

Since the sprocket 11a is adapted for use with a standard roller chain 50, the chordal pitch pa of a standard sprocket having the standard ISO tooth form is equal to the chain pitch p (that is, the distance between the centers of the successive rollers 52) of the standard roller chain 50. On the other hand, the chordal pitch pa11 of the sprocket 11a is larger than the chain pitch p of the standard roller chain 50. That is pa11>p.

On the other hand, the sprocket 11a has two kinds of tooth form pitch angles θ−Δθ and θ+Δθ having different sizes. That is the tooth form pitch angle θ−Δθ is smaller than the standard pitch angle θ by an amount Δθ, and the tooth form pitch angle θ+2Δθ is larger than the standard pitch angle θ by an amount 2Δθ. Δθ must be less than ¼ of the standard pitch angle θ (that is, Δθ<θ/4). This range is required in order to allow engagement of the sprocket with the rollers 52. Specifically, since the sprocket 11a has eighteen teeth, and θ=360°/z, the standard pitch angle θ for sprocket 11a is 20°. For Δθ to satisfy the relation Δθ<θ/4, Δθ must be less than 5°. The total of all the pitch angles θ−Δθ and θ+2Δθ is 360°, or 2π.

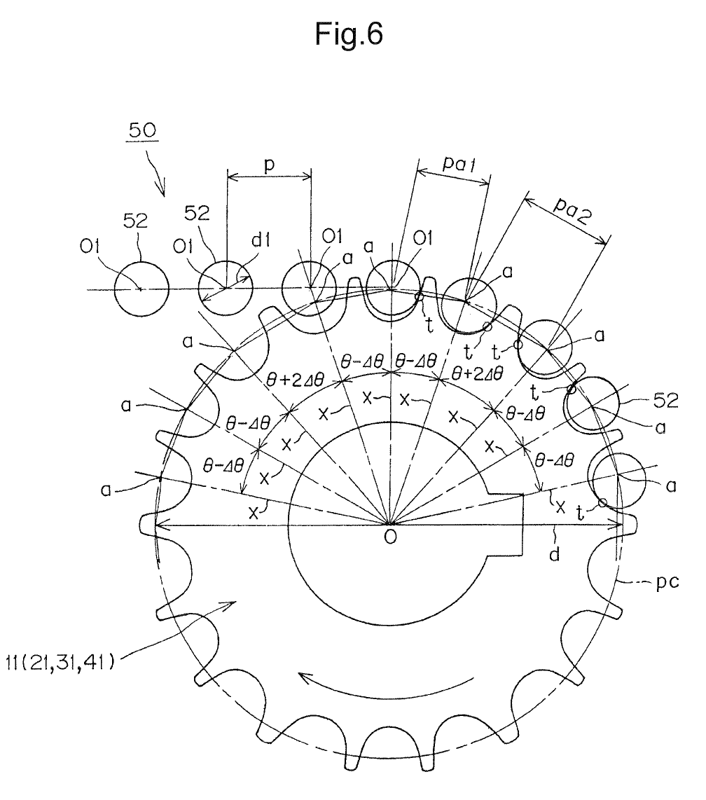

In the sprocket 11a, these two kinds of pitch angles θ−Δθ and θ+2Δθ are arranged irregularly along the circumferential direction of the pitch circle pc in sets each consisting of two pitch angles θ−Δθ followed by one pitch angle θ+2Δθ, as shown in FIG. 6.

The engagement of the standard roller chain 50 and the sprocket 11a in a first embodiment of the invention is shown in FIG. 6. The chordal pitch pa11, in FIG. 1, is determined in the same way as the tooth form pitches pa1 and pa2 in FIG. 6.

Since the standard roller chain 50 a uniform chain pitch p, and the sprocket 11 has two different tooth form pitch angles θ−Δθ and θ+2Δθ, and these tooth form pitch angles are arranged irregularly along the circumferential direction of the pitch circle pc in sets consisting of pitch angles θ−Δθ followed by one pitch angle θ+2Δθ, as the sprocket 11 rotates, a roller 52 moves relatively about the center O1 of an already seated preceding roller 52 in an arc having the chain pitch p as its radius. The seated roller 52 abuts the tooth gap bottom or a tooth surface of the sprocket 11 at an abutment position shown by small circle t in FIG. 6. In the case of abutment on a tooth surface, since the roller approaches the tooth surface in a substantially tangential direction, the kinetic energy of the roller is buffered so that the impact between the roller and the tooth surface is reduced. Accordingly, engagement noise is reduced.

Since the standard roller chain 50 has a uniform chain pitch p, and, on the other hand, the sprocket 11 has two different tooth form pitches, pa1 and pa2, which are chordal lengths corresponding to the two different tooth form pitch angles, and these tooth form pitches are irregularly arranged along the circumferential direction of the pitch circle pc in sets each consisting of two pitches pa1 and one pitch pa2, the abutment positions t vary from one roller to the next. Accordingly, the timing of the impact of the successive rollers is shifted, and vibration and noise at frequencies corresponding to the number of teeth on the sprocket are reduced.

The tooth form 11b in a sprocket according to a second embodiment of the invention is the same as the tooth form of the first embodiment as shown in FIG. 1.

Whereas the above-described first embodiment of the sprocket has two different pitch angles θ−Δν and θ+2Δθ, the sprocket 11b according to the second embodiment has three pitch angles: the standard pitch angle θ, which is 360°/z, a larger pitch angle θ+Δθ and a smaller pitch angle θ−Δθ. Here, as in the first embodiment, Δθ must be less ¼ of the standard pitch angle θ. That is, Δθ<θ/4. This range is required in order to allow proper engagement of the chain rollers 52 with the sprocket. Specifically, if the sprocket 11b has eighteen teeth the standard pitch angle θ is 20° and Δθ is less than 5°. That is Δθ<5°. The total of all the pitch angles of the sprocket θ, θ+Δθ and θ−Δθ is 360° or 2π.

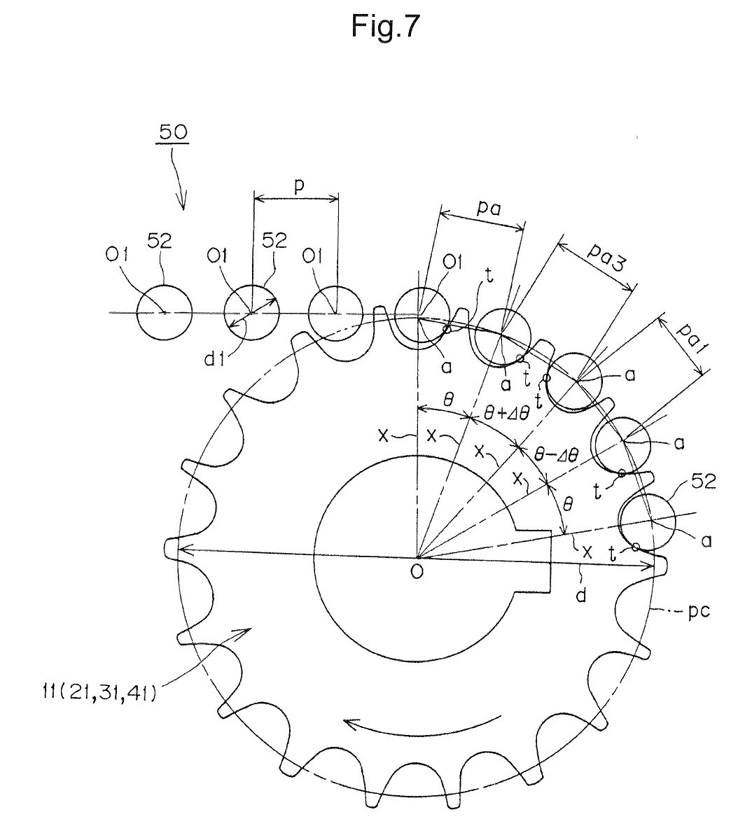

As shown in FIG. 7, in the sprocket of the second embodiment, these three pitch angles, θ, θ+Δθ and θ−Δθ, are arranged irregularly along the circumferential direction of the pitch circle pc in sets each consisting of one standard pitch angle θ, pitch angles θ+Δθ, and a pitch angle θ−Δθ. The tooth form pitch pa is a chordal length corresponding to the tooth form pitch angle θ. The tooth form pitch pa3 is a chordal length corresponding to the tooth form pitch angle θ+Δθ. The tooth form pitch pa1 is a chordal length corresponding to the tooth form pitch angle θ−Δθ. Thus, the sprocket 11b has three different tooth form pitches pa, pa3 and pa1, and these tooth form pitches are irregularly arranged along the circumferential direction of the pitch circle pc as one set of one tooth form pitch pa, one tooth form pitch pa3 and one tooth form pitch pa1.

The engagement of a standard roller chain 50 with the sprocket 11b according to the second embodiment of the invention is shown in FIG. 7. The tooth form pitches pa, pa1, and pa3 in FIG. 7 are determined in the same way that the chordal pitch pa11 in FIG. 1 is determined.

Since the standard roller chain 50 has uniform pitches p, the sprocket 11 has three different tooth form pitches, pa, pa3 and pa1, and these tooth form pitches are irregularly arranged along the circumferential direction of the pitch circle pc in sets each consisting one tooth form pitch pa, one tooth form pitch pa3 and one tooth form pitch pa1, when the sprocket 11 rotates, a roller 52 moves relatively about the center O1 of an already seated preceding roller 52 in an arc having the chain pitch p as its radius. The seated roller 52 abuts the tooth gap bottom or a tooth surface of the sprocket 11 at an abutment position shown by small circle t in FIG. 7. In the case of abutment on a tooth surface, since the roller approaches the tooth surface in a substantially tangential direction, the kinetic energy of the roller is buffered so that the impact between the roller and the tooth surface is reduced. Accordingly, engagement noise is reduced.

Since the standard roller chain 50 has a uniform chain pitch p, and, on the other hand, the sprocket 11 has three different tooth form pitches, pa, pa3 and pa1, which are chordal lengths corresponding to the three different tooth form pitch angles, and these tooth form pitches are irregularly arranged along the circumferential direction of the pitch circle pc in sets each consisting of one pitch pa, one pitch pa3, and one pitch pa1, the abutment positions t vary from one roller to the next. Accordingly, the timing of the impact of the successive rollers is shifted, and vibration and noise at frequencies corresponding to the number of teeth on the sprocket are reduced.

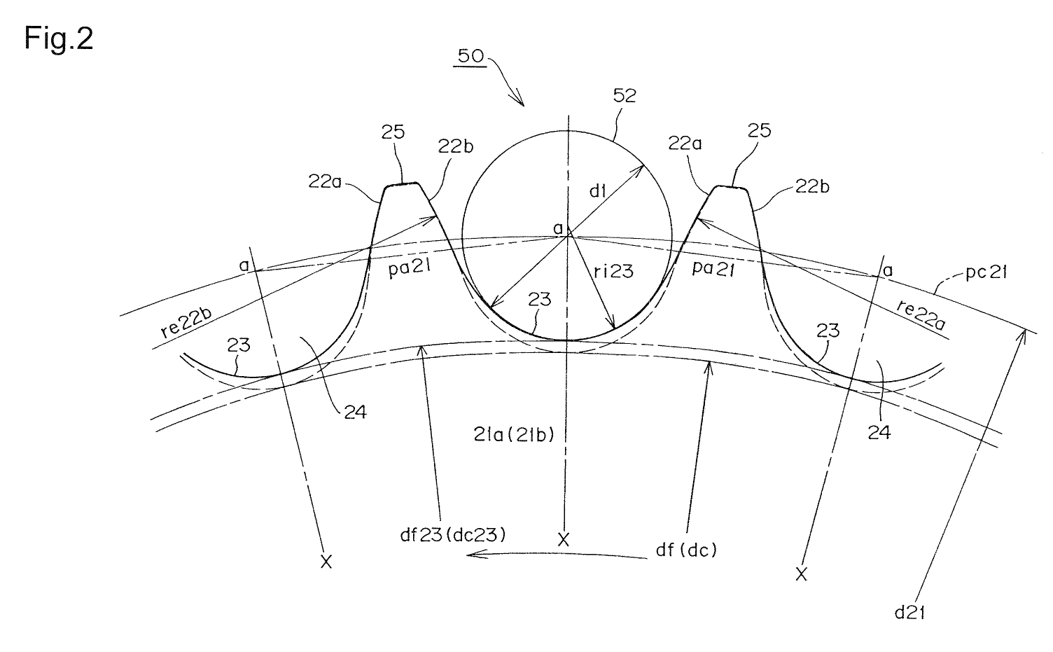

FIG. 2 shows a sprocket 21a according to a third embodiment of the invention. This sprocket has a tooth form different from the tooth form in the first and second embodiments. In the sprocket 21a, adjacent teeth 25 have facing tooth surfaces 22a and 22b, and are separated by a groove 24 having a tooth gap bottom 23, with which the tooth surfaces 22a and 22b are continuous. The standard ISO tooth form is shown by a broken line in FIG. 2 for comparison.

The tooth surface 22a, on the front side of a tooth in the direction of rotation of the sprocket 21a, and the tooth surface 22b on the back surface of the preceding tooth, are symmetrical with respect to a center line X, which extends from the rotational center of the sprocket 21a through the center of the tooth gap bottom 23 between the two teeth. Each of the tooth surfaces 22a and 22b is in the form of a convex arc. The arcs forming the tooth surfaces 22a and 22b have radii re12a and re12b, respectively, both of which are equal to the radius re (FIG. 9) of the arc-shaped tooth surfaces in the Standard ISO tooth form. That is, re12a=re and re12b=re.

The tooth gap bottom 23 is in the form of an arc having its center on the tooth gap bottom center line X, and having a radius ri23, which is larger than the radius ri (FIG. 9) of the arc-shaped tooth gap bottom in the standard ISO tooth form. That is, ri23>ri. The center of the arc-shaped tooth gap bottom 23 is located on the center line X, radially outward relative to the location of the center of the arc-shaped tooth gap bottom in a sprocket having standard ISO tooth form, the same number of teeth.

Since the center of the arc-shaped tooth gap bottom 23 is positioned outward relative to the center of the arc-shaped tooth gap bottom in a corresponding sprocket having the standard ISO tooth form, the diameter of tooth gap bottom circle of the sprocket is larger than the diameter of the tooth gap bottom circle of the standard sprocket. In particular, when the number z of teeth on the sprocket 21a is even, the diameter df23 of the tooth gap bottom circle is larger than a diameter df of the tooth gap bottom circle in the sprocket having the standard ISO tooth form. That is, df23>df. Alternatively, when the number z of teeth on the sprocket 21a is odd, the caliper diameter dc23 is larger than the caliper diameter dc in the sprocket having the standard ISO tooth form. That is, dc23>dc.

Furthermore, since the diameter df 23 of the tooth gap bottom circle, or the caliper diameter dc23, is larger than the diameter df of the tooth gap bottom circle or the caliper diameter dc in the standard ISO tooth form, the chordal pitch pa21 of the sprocket 21a (that is, the distance between successive intersection points a of the pitch circle pc21 and center lines X of the tooth gap bottoms) is larger than the chordal pitch pa (that is, the distance between successive intersection points a of a pitch circle pc and the center lines X of tooth gap bottoms in a standard sprocket having the standard ISO tooth form as shown in FIGS. 8 and 9. That is, pa21>pa.

Since the sprocket 21a is adapted for use with a standard roller chain 50, the chordal pitch pa of a standard sprocket having the standard ISO tooth form is equal to the chain pitch p (that is, the distance between the centers of the successive rollers 52) of the standard roller chain 50. On the other hand, the chordal pitch pa21 of the sprocket 21a is larger than the chain pitch p of the standard roller chain 50. That is pa21>p.

The tooth form pitch angles of the sprocket 21a of the third embodiment are the same as the tooth form pitch angles in the first embodiment.

In a fourth embodiment of the invention, the sprocket tooth form is the same as that of the third embodiment, i.e., the same as that of sprocket 21b shown in FIG. 2, but the pitch angles and tooth form pitches of the sprocket 21b are the same as those of the second embodiment. That is, the pitch angles are θ, θ+Δθ and θ−Δθ, and the tooth form pitches are pa, pa3, and pa1, as shown in FIG. 7

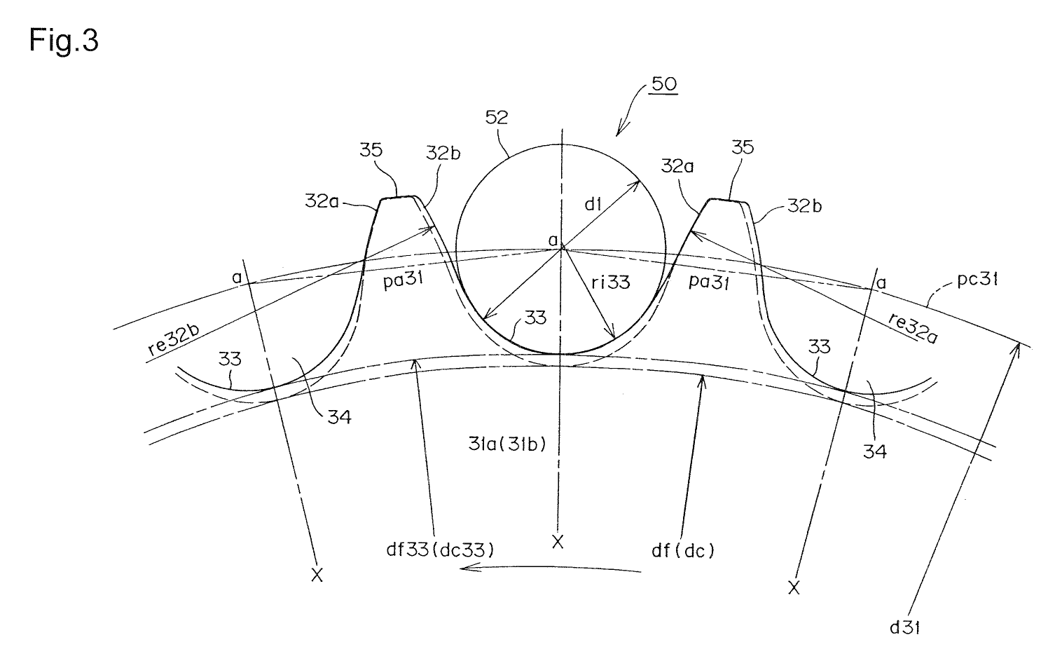

In a fifth embodiment, a sprocket 31a has a tooth form as shown in FIG. 3, and is adapted for use with a standard roller chain. In the sprocket 31a, adjacent teeth 35 have facing tooth surfaces 32a and 32b, and are separated by a tooth groove 34 having a tooth gap bottom 33, with which the tooth surfaces 32a and 32b are continuous. A standard ISO tooth form is shown by a broken line in FIG. 3 for comparison.

The tooth surface 32a on the front side of a tooth in the rotational direction of the sprocket 31a, and the tooth surface 32b on the back side of the preceding tooth, are smoothly continuous with the tooth gap bottom 33, but asymmetrically disposed on right and left sides of a center line X connecting the rotational center of the sprocket 31a with the center of each tooth gap bottom 33. The tooth surface 32a is in the form of a convex arc. The arc forming the tooth surface 32a has a radius re32a which is the same as the radius re of an arc-shaped tooth surface in the standard ISO tooth form. That is, re32a=re. The tooth surface 32b is also in the form of a convex arc, but the radius re32b of the arc of tooth surface 32b is larger than a radius re of an arc-shaped tooth surface in the standard ISO tooth form. Therefore, re32b>re.

The tooth gap bottom 33 is in the form of an arc having its center on the tooth gap bottom center line X. The radius ri33 of the tooth gap bottom arc is larger than the radius ri of an arc-shaped tooth gap bottom in the standard ISO tooth form as shown in FIG. 9. That is, ri33>ri. The center of the arc having the radius ri33 is positioned radially outward on center line X relative to the position of the center of the arc of the tooth gap bottom in the Standard ISO tooth form, having a radius ri.

Furthermore, since the center of the arc of the tooth gap bottom 33, having a radius ri33, is positioned outward relative to the center of the arc of the tooth gap bottom in the standard ISO tooth form, when the number z, of teeth of the sprocket 31a, is even, the diameter df33 of the tooth gap bottom circle is larger than the diameter df of the tooth gap bottom circle in the standard ISO tooth form. That is df33>df. Alternatively, when the number z, of teeth of the sprocket 31a, is odd, the caliper diameter dc33 is larger than the caliper diameter dc in the standard ISO tooth form. That is, dc33>dc.

Furthermore, since the diameter df 33 of the tooth gap bottom circle, or the caliper diameter dc33, is larger than the diameter df of the tooth gap bottom circle or the caliper diameter dc in the standard ISO tooth form, the chordal pitch pa31 of the sprocket 31a (that is, the distance between successive intersection points a of the pitch circle pc31 and center lines X of the tooth gap bottoms) is larger than the chordal pitch pa (that is, the distance between successive intersection points a of a pitch circle pc and the center lines X of tooth gap bottoms in a standard sprocket having the standard ISO tooth form as shown in FIGS. 8 and 9. That is, pa31>pa.

Since the sprocket 31a is adapted for use with a standard roller chain 50, the chordal pitch pa of a standard sprocket having the standard ISO tooth form is equal to the chain pitch p (that is, the distance between the centers of the successive rollers 52) of the standard roller chain 50. On the other hand, the chordal pitch pa31 of the sprocket 31a is larger than the chain pitch p of the standard roller chain 50. That is pa31>p.

The tooth form pitch angles of sprocket 31a of the fifth embodiment are the same as the tooth form pitch angles of the first embodiment, as shown in FIG. 6.

In a sixth embodiment of the invention, the tooth form of the sprocket is the same as the tooth form of the sprocket 31b of the fifth embodiment, as shown in FIG. 3, and the pitch angles of the sprocket 31b are the same as the tooth form pitch angles of the second embodiment, as shown in FIG. 7.

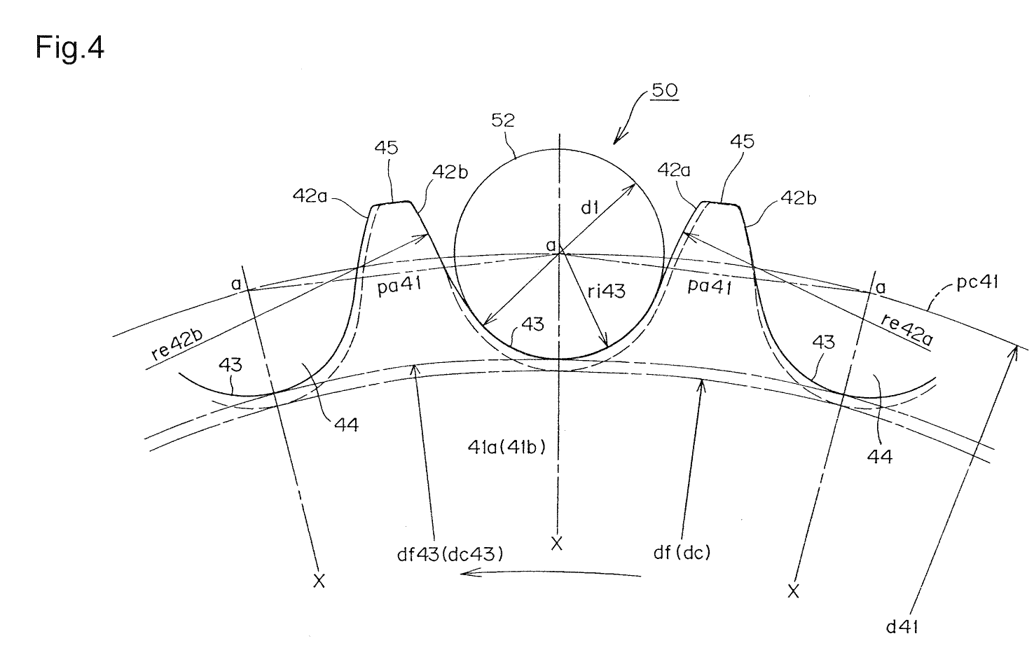

In a seventh embodiment, a sprocket 41a has a tooth form as shown in FIG. 4, and is adapted for use with a standard roller chain. In the sprocket 41a, adjacent teeth 45 have facing tooth surfaces 42a and 42b, and are separated by a tooth groove 44 having a tooth gap bottom 43, with which the tooth surfaces 42a and 42b are smoothly continuous. A standard ISO tooth form is shown by a broken line in FIG. 4 for comparison.

The tooth surface 42a on the front side of a tooth in the rotational direction of the sprocket 41a, and the tooth surface 42b on the back side of the preceding tooth, are smoothly continuous with the tooth gap bottom 43, but asymmetrically disposed on right and left sides of a center line X connecting the rotational center of the sprocket 41a with the center of each tooth gap bottom 43. The tooth surface 42a is in the form of a convex arc. The arc forming the tooth surface 42a has a radius re42a which is larger than a radius re of an arc-shaped tooth surface in the standard ISO tooth form. Therefore, re42b>re. On the other hand, the radius re42b of tooth surface 42b, which is also in the form of a convex arc, is the same as the radius re of an arc-shaped tooth surface in the standard ISO tooth form. That is, re42b=re.

The tooth gap bottom 43 is in the form of an arc having its center on the tooth gap bottom center line X. The radius ri43 of the tooth gap bottom arc is larger than the radius ri of an arc-shaped tooth gap bottom in the standard ISO tooth form shown in FIG. 9. That is, ri43>ri. The center of the arc having the radius ri43 is positioned radially outward on center line X relative to the position of the center of the arc of the tooth gap bottom in the Standard ISO tooth form, having a radius ri.

Furthermore, since the center of the arc of the tooth gap bottom 43, having a radius ri43, is positioned outward relative to the center of the arc of the tooth gap bottom in the standard ISO tooth form, when the number z, of teeth of the sprocket 41a, is even, the diameter df43 of the tooth gap bottom circle is larger than the diameter df of the tooth gap bottom circle in the standard ISO tooth form. That is df43>df. Alternatively, when the number z, of teeth of the sprocket 41a, is odd, the caliper diameter dc43 is larger than the caliper diameter dc in the standard ISO tooth form. That is, dc43>dc.

Furthermore, since the diameter df 43 of the tooth gap bottom circle, or the caliper diameter dc43, is larger than the diameter df of the tooth gap bottom circle or the caliper diameter dc in the standard ISO tooth form, the chordal pitch pa41 of the sprocket 41a (that is, the distance between successive intersection points a of the pitch circle pc41 and center lines X of the tooth gap bottoms) is larger than the chordal pitch pa (that is, the distance between successive intersection points a of a pitch circle pc and the center lines X of tooth gap bottoms in a standard sprocket having the standard ISO tooth form as shown in FIGS. 8 and 9. That is, pa41>pa.

Since the sprocket 41a is adapted for use with a standard roller chain 50, the chordal pitch pa of a standard sprocket having the standard ISO tooth form is equal to the chain pitch p (that is, the distance between the centers of the successive rollers 52) of the standard roller chain 50. On the other hand, the chordal pitch pa41 of the sprocket 41a is larger than the chain pitch p of the standard roller chain 50. That is pa41>p.

The tooth form pitch angles of sprocket 31a of the seventh embodiment are the same as the tooth form pitch angles of the first embodiment, as shown in FIG. 6.

In a sprocket 41b according to an eighth embodiment of the invention, the tooth form of the sprocket is the same as the tooth form of the seventh embodiment, as shown in FIG. 4, and the tooth form pitch angles of the sprocket are the same as the tooth form pitch angles of the second embodiment, as shown in FIG. 7.

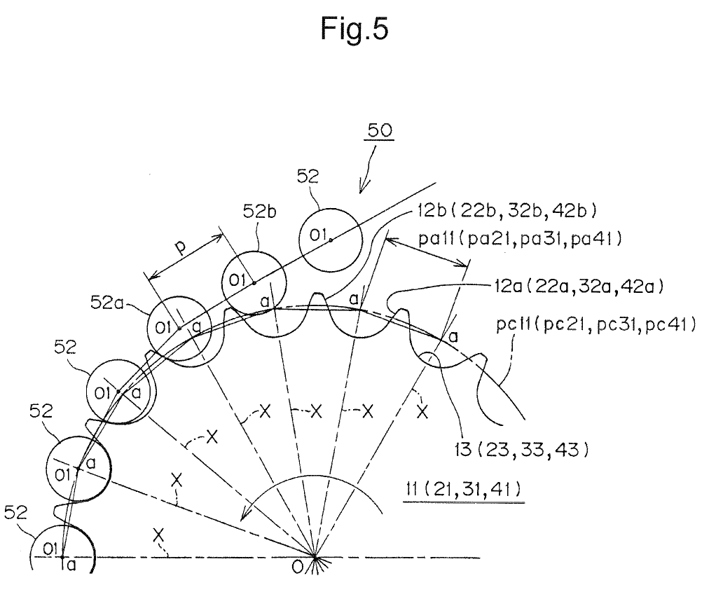

The engagement of a standard roller chain with a sprocket is the same for each of the sprockets 11a, 11b, 21a, 21b, 31a, 31b, 41a, 41b according to the above-described embodiments, and is depicted in FIG. 5, wherein the sprockets are designated 11, 21, 31, and 41.

The sprockets can be used in an engine timing drive to transmit rotation from an engine crankshaft to a valve-operating camshaft. The sprockets can also be used as idler sprockets, used to change the direction of a timing chain.

When tension is applied to the standard roller chain 50 by the rotation of a crankshaft, rollers 52 of the standard roller chain sequentially engage tooth grooves of the sprocket as the sprocket rotates counterclockwise. As the sprocket rotates a following roller 52b pivots, relative to an already seated preceding roller 42a, about the center O1 of the preceding roller, in an arc having a radius equal to the chain pitch p. Since the chordal pitch, e.g., pa11, of the sprocket, is larger than the chain pitch p, the following roller 52b abuts a back side tooth surface, e.g. surface 12b, approaching the tooth surface in a substantially tangential direction. Because of the tangential approach, the impact resulting from this to relative pivoting movement is small, and a reduction in impact noise is realized. The engagement position of the roller 52b moves to the tooth gap bottom 13 as the sprocket rotates, so that the roller 52b is supported at the central portion of the tooth gap bottom 13. The movement of the roller 52b to the tooth gap bottom is a rolling motion, so that no noise is generated.

Although not shown, on disengagement of the chain from the sprocket, a preceding roller pivots relatively about the center O1 of a following subsequent roller in an arc having a radius equal to the chain pitch p. At the location at which disengagement takes place, The preceding roller will be in abutment only with a front tooth surface, e.g. a surface 12a, and can easily separate from its abutment position by a pivoting motion. Therefore, disengagement of the rollers from the sprocket 11 can take place smoothly.

Engagement of sprockets 21, 31, 41 with the standard roller chain 50 in the third to eighth embodiments takes place in the same manner as the engagement of the sprocket 11 with the standard chain 50 as shown in FIG. 5.

A reduction in overall noise and vibration is achieved as follows. Since the diameter of the tooth gap bottom circle (i.e., the root diameter) is larger than the diameter of a tooth gap bottom circle of a standard sprocket having the standard ISO tooth form, the chordal pitch of the sprocket is larger than the chain pitch p of the standard roller chain 50. Accordingly, on engagement of a roller with the sprocket, the roller first abuts a back tooth surface, e.g., a surface 12b, 22b, 32b, or 42b, in a substantially tangential direction, and consequently impact due to relative movement and noise due to impact is reduced.

Furthermore on disengagement, a roller is only in abutting relationship with a front tooth surface, e.g., a surface 12a, 22a, 32a, or 42a. The roller can therefore separate smoothly and easily from the sprocket by a pivoting movement about the center of the immediately following roller, without being inhibited as in the case of a conventional low noise chain transmission such as the one described in the above-mentioned Japanese Examined Patent Application No. Hei 7-18478.

As will be apparent from FIGS. 6 and 7, because the standard roller chain 50 has a uniform chain pitch p, and the sprockets have two or more different pitch angles arranged irregularly along the circumferential direction of the pitch circle pc, kinetic energy of the rollers 52, as they engage the tooth surfaces of the sprocket, is buffered so that the impact is small and engagement noise is reduced. Furthermore, since the timing of the impact or abutment of the roller 52 with the sprocket teeth shifts, vibration and noise, at frequencies corresponding to the number of teeth are reduced. Furthermore, since the difference between the overall noise of the chain transmission and the periodic sounds that it generates is large, gating noises can be reduced.

Since the of teeth are integrally molded with the entire sprocket by sintering, the irregularly pitched teeth, which are difficult to form by machining or rolling, can be made easily. In addition, friction due to sliding contact between the tooth surface and the chain rollers, which would otherwise be increased due to the irregularity of the sprocket tooth pitch, is reduced because of the superior lubricant-holding capacity of the sintered sprocket teeth.

Although the invention has been described with reference to embodiments in which the chain is a standard roller chain, the advantages of the invention can be realized in embodiments in which the chain is a standard rollerless bushing chain. Furthermore, although the embodiments described have sprocket tooth forms different from those of a standard sprocket, advantages of the invention can be realized even if the tooth forms are the same as those of a standard sprocket, provided that the diameter of the tooth gap bottom circle is larger than the diameter of the tooth gap bottom circle of a standard sprocket, the sprocket has at least two different pitch angles arranged irregularly in the direction of the circumference of the sprocket's pitch circle, and the sprocket teeth are integrally molded as a part of the sprocket by sintering.

In all embodiments, the maximum outer diameter of the tooth form is preferably matched to the maximum diameter of a standard sprocket in order to ensure compatibility with a chain transmission using a conventional, standard, sprocket.

We claim:

1. A sprocket for a chain drive, the sprocket having teeth separated by grooves for receiving rollers or bushings of a transmission chain, in which:
in each said groove, facing tooth surfaces are continuous with a tooth gap bottom;
the sprocket has at least two different pitch angles arranged irregularly in the direction of the circumference of the sprocket's pitch circle;
the diameter of tooth gap bottom circle of the sprocket is larger than the diameter of the tooth gap bottom circle of a standard sprocket having the same number of teeth; and
said teeth are integrally molded as a part of the sprocket by sintering.

2. A sprocket according to claim 1, in which said tooth form pitch angles are θ−Δθ and θ+2Δθ, arranged irregularly in the direction of the circumference of the sprocket's pitch circle, and in which θ is the pitch angle of a standard sprocket.

3. A sprocket according to claim 1, in which said tooth form pitch angles are θ−Δθ and θ+2Δθ, arranged irregularly in the direction of the circumference of the sprocket's pitch circle, in which the number of pitch angles in the sprocket equal to θ−Δθ is two times the number of pitch angles in the sprocket equal to θ+2Δθ, and in which θ is the pitch angle of a standard sprocket.

4. A sprocket according to claim 1, in which said tooth form pitch angles are θ, θ−Δθ, and θ+Δθ, arranged irregularly in the direction of the circumference of the sprocket's pitch circle, and in which θ is the pitch angle of a standard sprocket.

5. A sprocket according to claim 1, in which said tooth form pitch angles are θ, θ−Δθ, and θ+Δθ, arranged irregularly in the direction of the circumference of the sprocket's pitch circle, in which the number of pitch angles in the sprocket equal to θ−Δθ is equal to the number of pitch angles in the sprocket equal to θ+Δθ, and in which θ is the pitch angle of a standard sprocket.
